(19) United States
(12) Patent Application Publication
(10) Pub. No.: US 2024/0116071 A1
(43) Pub. Date: Apr. 11, 2024

(54) PUMP MECHANISM TO CONTROL SEALANT DISPENSING

(71) Applicant: Wilder Systems Inc., Austin, TX (US)

(72) Inventors: Daniel MORAN, Austin, TX (US); William WILDER, Austin, TX (US)

(21) Appl. No.: 18/478,865

(22) Filed: Sep. 29, 2023

Related U.S. Application Data
(60) Provisional application No. 63/378,463, filed on Oct. 5, 2022.
(60) Provisional application No. 63/482,502, filed on Jan. 31, 2023.

(51) Int. Cl. B05C 5/02; F04B 43/12

(52) U.S. Cl. CPC B05C 5/0225; F04B 43/1261

(57) ABSTRACT

A pump mechanism for dispensing a sealant is described. The pump mechanism can include a housing comprising a cavity; a tubing track arranged in the cavity, the tubing track having a curved surface inward from the housing; a tubing arranged in proximity to the curved surface of the tubing track; a rotor assembly arranged inward from the curved surface and the tubing, the rotor assembly comprising a rotor and a first roller in contact with the tubing, the first roller compressing the tubing to reduce fluidic communication between a first end and a second end of the tubing; a motor in operable communication with the rotor assembly; and a computing device configured to control a rotational speed of the rotor based on a velocity of a tool center point (TCP) of the robot.

### CROSS-REFERENCES TO RELATED APPLICATIONS

This application claims the benefit of prior filed U.S. Provisional Patent Application No. 63/378,463 filed Oct. 5, 2022 and U.S. Provisional Patent Application No. 63/482,502 filed Jan. 31, 2023, which is hereby incorporated by reference herein in its entirety.

### BACKGROUND

Industrial robotics is an expanding field for various industries that want to improve their internal and customer-facing processes. Industrial robots can be fabricated and programmed to perform various tasks for different applications. This customizability has led many enterprises to expand the incorporation of robots from manufacturing to other processes to improve the safety and the efficiency of the enterprise's workers.

### BRIEF DESCRIPTION OF THE DRAWINGS

Various embodiments in accordance with the present disclosure will be described with reference to the drawings in which:

FIG. 1 is an illustration of a robot with a pump mechanism for controlling sealant dispending, according to one or more embodiments.

FIG. 2 is an illustration of a peristaltic pump, according to one or more embodiments.

FIG. 3 is an illustration of a nozzle for a pump mechanism, according to one or more embodiments.

FIG. 4 is an illustration of a cross-section to receive a sealant, according to one or more embodiments.

FIG. 5 is an illustration of an environment for sealant dispensing, in accordance with one or more embodiments.

FIG. 6 is a process flow for dispensing a sealant on a target object, in accordance with one or more embodiments.

FIG. 7 is a block diagram of an example of a computing device, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Aircraft can be comprised of a fuselage, wings, engines, empennage, and an undercarriage. Aircraft manufacturers use sealants to create airtight seals for joints, gaps, and rivets of the aircraft. For example, poly-sulfide based sealants are common in the aircraft manufacturing industry for creating seals in the construction and maintenance phases of an aircraft's lifecycle.

As aircraft servicing entities transition to robotic labor to perform these tasks, there is an increased need for automation of these tasks, including sealant dispensation. To automate this process, a robot needs the capability to evaluate the dimensions of a crevice needing sealant and to regulate the flow of sealant from a pump with regard to the velocity of a robot's tool center point (TCP). The TCP can be analogous to a position of a nozzle on the end of a robotic arm that dispenses the sealant. Conventional automated sealant application methods are inadequate as the sealant is dispensed at a uniform rate. Therefore, if the velocity of the TCP is high, the amount of sealant applied can be inadequate. If, however, the velocity of the TCP is low, too much sealant can be applied.

Embodiments described herein address the above-referenced issues via a robot that can be deployed to an aircraft for sealant dispensation. The robot can include a pump mechanism that can regulate the flow of sealant dispensing, using feedback based on a velocity of the TCP. The pump mechanism can include a pressure unit connected to a peristaltic pump. The pressure unit can be used for pushing a sealant into one end of the peristaltic pump. The peristaltic pump can include a roller that rotates to draw the sealant into the pump and dispense the sealant from a nozzle. The peristaltic pump can include a rotor that rotates based on a motor. The pump mechanism can further include feedback that can be used to adjust the rotation of the rotor based on the TCP velocity. By adjusting the rotation, the pump mechanism can regulate the amount of sealant is applied based on the TCP velocity. The nozzle can include a nozzle configured for dispensing a sealant. The nozzle can include an opening for dispensing the sealant. The nozzle can further include a spatula nozzle that follows the nozzle to sweep the sealant such that it is flush with the surface of the aircraft.

It should be appreciated that the embodiments described herein relate to applying a sealant on an aircraft for illustration purposes. The pump mechanism described here can be used to dispense a fluid on a variety of objects and for a variety of purposes. For example, the pump mechanism can dispense the fluid on seacraft, land crafts, or non-craft objects, such as structures. The pump mechanism can further be used for a variety of purposes, such as dispensing fluid between objects, dispensing fluid on the surface of an object, dispensing in a gap or a crack in the object.

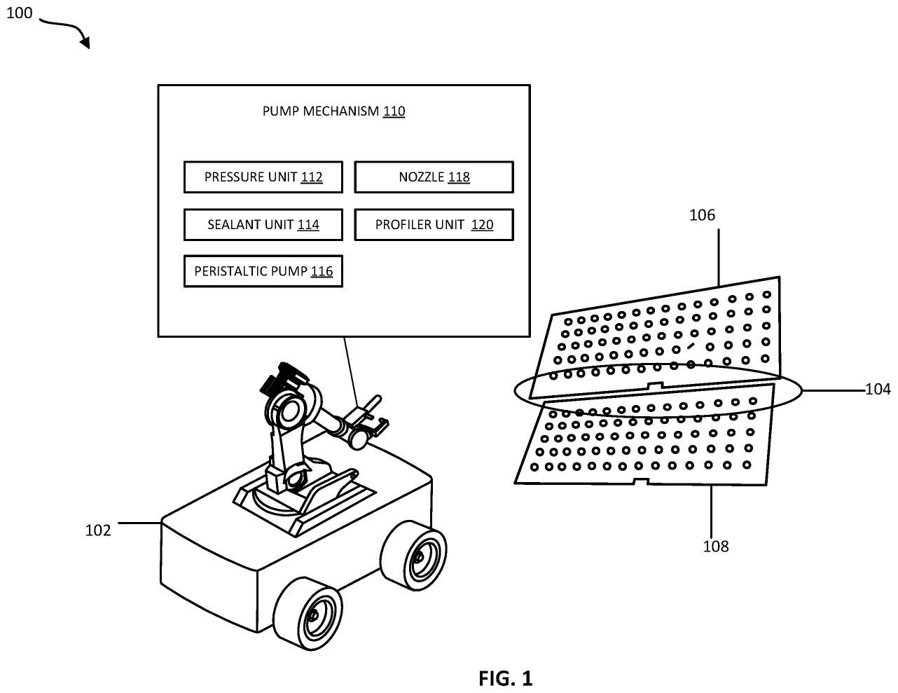

FIG. 1 is an illustration 100 of a robot with a pump mechanism for controlling sealant dispending, according to one or more embodiments. As illustrated, a robot 102 can be deployed to apply a sealant on a target object. As illustrated, the target object can be an aircraft with a gap 104 between a first panel 106 and a second panel 108. In other instances, the robot 102 can be deployed to apply a sealant at a crack in a panel, over fastener, or other appropriate area.

The robot 102 can include a pump mechanism 110, which can be connected to the robot 102. For example, one or more components of the pump mechanism 110 can be connected to an end of a robot arm. The pump mechanism unit can include a pressure unit 112 for exerting pressure against a sealant to force the sealant to move in a direction toward a pump. For example, the pressure unit 112 can include an air cylinder, motor-based actuator, solenoid actuator, or other appropriate device for forcing a sealant to move in a target direction. The amount of pressure exerted by the pressure unit 112 can be controlled, for example, by a computing device, such as a user computing device or a server.

The pump mechanism 110 can further include a sealant unit 114 for holding a sealant. For example, the sealant unit 114 can include a container, such as a tube OR a cartridge, for holding the sealant. The sealant unit 114 can function, for example, by receiving pressure from the pressure unit 112 at one end and releasing sealant from another end.

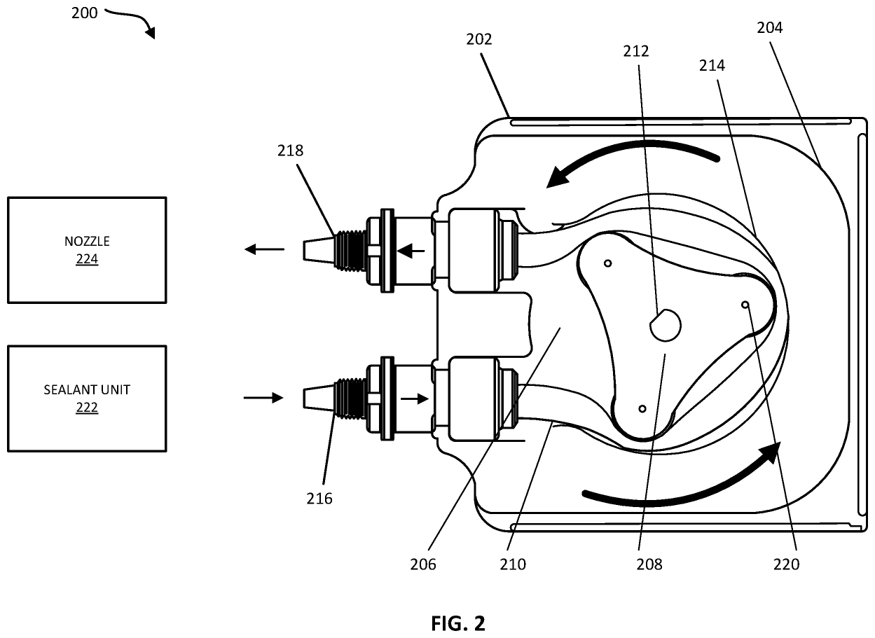

The pump mechanism 110 can further include a peristaltic pump 116, which can be a positive displacement pump for transporting a sealant through a series of rollers from a sealant unit 114 to a nozzle 118. The peristaltic pump 116 can include a rotor connected to the rollers and powered by a motor. The rollers can each pinch a tubing that carries the sealant through the peristaltic pump 116. The rotation of rotor can cause the rollers to rotate to draw sealant from the sealant unit 114 and dispense sealant from the nozzle 118. The peristaltic pump 116 is described with more particularity with respect to FIG. 2.

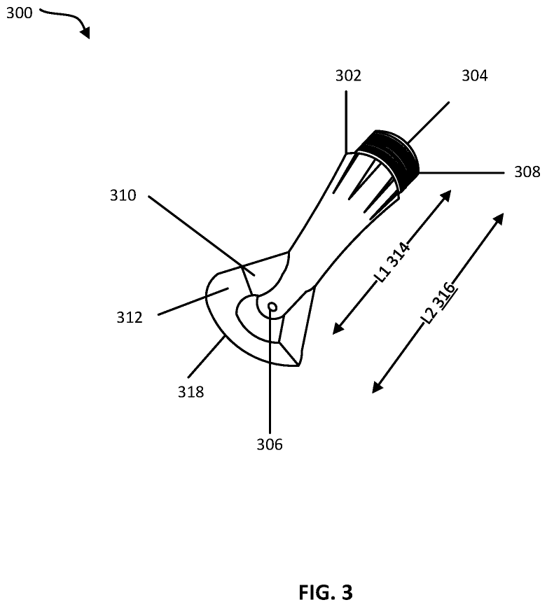

The pump mechanism 110 can further include a nozzle 118 for dispensing sealant on a target object. For example, the nozzle 118 can dispense sealant. The nozzle can have a generally tubular structure with a hollow cross-section to allow sealant to be received from the peristaltic pump 116 at a first end, and be transmitted through the nozzle 118 to be dispensed onto a target object at a second end. The nozzle 118 can further include a spatula at the second end. The spatula can project away from the nozzle 118 and be arranged to scrape the surface of the target object, such that the spatula pushes a portion of the dispensed sealant forward and leaves a balance of the sealant to be flush with a surface of the target object. The nozzle 118 is described with more particularity with respect to FIG. 3.

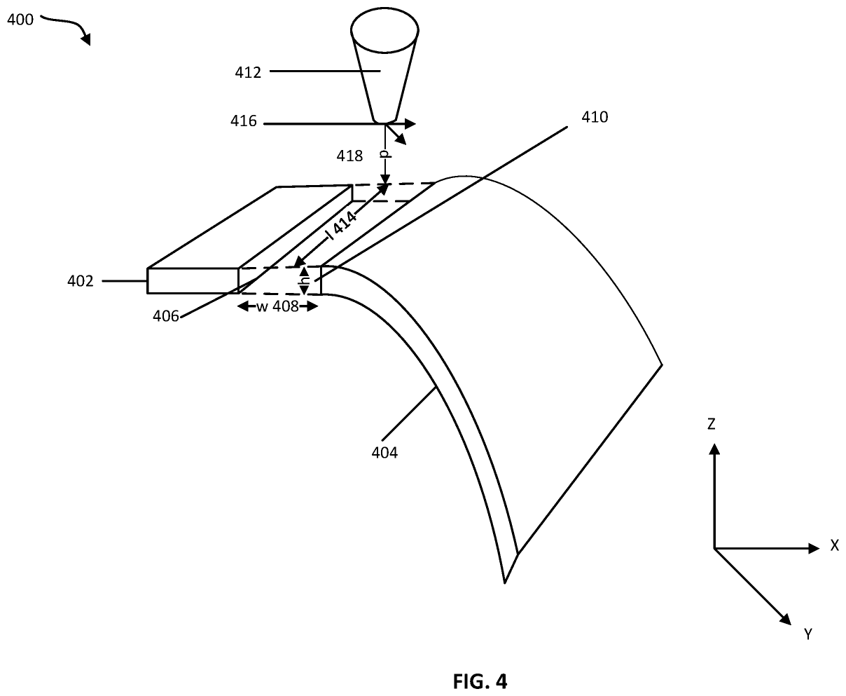

The pump mechanism 110 can further include a profiler unit 120. The profiler unit 120 can be configured to determine a cross-section of a gap upon which sealant is to be applied. The cross-section can include a width and a depth of the gap, which can be used to determine the amount of sealant to dispense from the pump mechanism 110. For example, the wider the width or the deeper the depth of the cross-section, the more sealant can be needed to fill the gap. The width and depth dimensions of the cross-section can vary along the length of the gap. Therefore, the profiler unit 120 can scan the gap over the length of the gap and determine the cross-section dimension along the length. The profile unit 120 can include, for example, a displacement sensor such as a laser profiler. The laser profiler can emit a laser light through an emitting lens toward a target object (e.g., the gap in the target object). The laser profiler can further include an array of receiving elements for collecting light across a laser line emitted from the target object. The laser profiler can further include a position detector for detecting a center position of the laser line as the laser profiler moves along the length of the gap. The position detector can further help determine a center point of the laser light emitted at the target object at a given point. The laser profiler can determine a width and depth of the gap at a given point based on the light emitted, the center position of the laser line, and the amount of light reflected from the target object that the laser profiler has collected. The cross-section is defined with more particularity with respect to FIG. 4.

The pump mechanism 110 can regulate the amount of sealant that is dispensed from the nozzle 118 based on a velocity of the robot's TCP, where the TCP can be the tip of the nozzle 118. A processing unit including a controller can cause each joint of the robot 102 to move in a particular manner. For example, using inverse kinematics, the processing unit can determine a set of motions in three-dimensional space for the robot to move from a current pose to a target pose. To make the calculations, the processing unit can use the end of the robot arm as a reference point. In the event that a tool, such as a pump mechanism 110 is added to the robot arm, the processing unit can change the reference point from the end of the arm to the end of the tool. The TCP permits a controller mechanism to make adjustment accounting for the offset between the end of the robot arm and the tip of the tool. As described herein, the tip of the tool can be the tip of the nozzle 118. For example, the pump mechanism can be attached to the end of the robot arm at a flange on the end of the robot arm. The offset can include the distance between the flange and the tip of the nozzle 118. Based on the TCP, the processing unit can transform the coordinate system without a tool to a coordinate system with the tool.

The amount of sealant that is dispensed from the nozzle 118 can be regulated based on the rotational speed of the rotor. Furthermore, as described above, the amount of sealant that is actually deposited on the target object, can be based on a velocity of the TCP. Therefore, to ensure that an appropriate amount of sealant is dispensed from the nozzle 118 to fill the gap, the rotational speed of the peristaltic pump rotor can be based on the velocity of the TCP. In addition to the velocity of the TCP, the rotational speed of the peristaltic pump rotor can be based on the cross-section dimensions of the gap. For example, the wider the width or the deeper the depth, the faster the rotational speed of the rotor can be set to cause the pump to dispense more sealant. Therefore, as the profiler unit 120 is scanning the gap to determine the cross-section dimensions, the pump mechanism 110 can receive real-time feedback data to adjust the rotational speed of the peristaltic pump rotor.

FIG. 2 is an illustration 200 of a peristaltic pump, according to one or more embodiments. The peristaltic pump 202 includes a housing 204 with a cavity 206 for holding rotor assembly 208 and a tubing 210. The rotor assembly 208 can include a shaft 212 that is connected to a motor that turns the shaft 212. The tubing 210 can be arranged inwards from a tubing track 214. The tubing track 214 has a generally curved inner surface and can guide the tubing from an intake 216, around the rotor assembly 208, and to an output 218. As illustrated, the rotor assembly rotates in a counterclockwise direction. However, based on the motor, the rotor assembly 208 can rotate in a clockwise direction.

The rotor assembly 208 can include one or more rollers 220. As illustrated, there are three rollers, but in other instances, there can be any number of rollers, one or greater. Each roller 220 can press the tubing against the surface of the tubing track, such that a fluid (e.g., sealant) cannot pass through the point that the roller 220 makes contact with the tubing 210. In other words, the roller can hinder the fluidic communication between one end of the tubing and another end. As the rotor assembly rotates, a volume of sealant is held in the tubing between a point of contact of the rollers. The sealant is held in pockets of tubing 210 between the rollers 220. The motor causes the rotor assembly 208 to rotate in the counterclockwise direction.

As the rotor assembly rotates, the sealant from a sealant unit 222 is drawn into the intake 216 and into the tubing 210. The sealant unit 222 can further be connected to a pressure unit that creates a pressure to push the sealant into the intake 216. The sealant unit 222 can be connected to the intake 216 via additional tubing that carries the sealant from the sealant unit 222 to the intake 216.

As the rotor assembly 208 rotates, the sealant is squeezed through the tubing 210 by the rollers 220 and around the rotor assembly 208 and towards the output 218. The faster the rotor assembly rotates, the faster the rollers 220 rotates about the rotor assembly 208. As the rollers 220 pinch the tubing 210 and rotate, the sealant moves through the tubing 210. Therefore, the amount of sealant that is squeezed into the output 218 is based on the speed of the rotor assembly 208. The output 218 can be connected to a nozzle 224 that can dispense a sealant on a target object. For example, the output 218 can be connected to the nozzle via additional tubing. In addition to squeezing the sealant into the output 218, the rollers 220 prevent the sealant from moving in a clockwise direction towards the intake 216.

Therefore, it can be seen that the amount of sealant that is squeezed into the output 218 is based on the rotational speed of the rotor assembly 208. The rotor assembly 208 is driven to rotate by the shaft 212 that is connected to a motor. It should also be appreciated that the amount of sealant deposited on the target object is based on velocity of the TCP. For example, keeping the flow of sealant dispensing from the nozzle 224 constant, if the nozzle 224 is moving over the surface of the target object at a slow speed, the amount sealant deposition will be greater than if the nozzle 224 is moving over the surface of the target object at a fast speed. Therefore, the rotation of the rotor assembly 208 can be based on the velocity of the TCP. A profiler unit can provide cross-section dimensions of the gap. The robot can determine the amount of sealant that needs to be deposited to fill the gap at the cross-section. The robot can detect the velocity of the nozzle tip (e.g., TCP) over the surface of the target object. The robot arm is moving the nozzle tip and therefore, the robot can calculate the velocity of the nozzle tip connected to its own arm. The robot can further adjust the rotational speed of the rotor assembly 208, such that the correct amount of sealant is deposited based on the velocity of the nozzle tip.

FIG. 3 is an illustration 300 of a nozzle for a pump mechanism, according to one or more embodiments. The nozzle 302 can include an input orifice 304 at a proximal end for receiving a sealant. The nozzle 302 can further include an output orifice 306 at a distal end for dispensing the sealant. The input orifice 304 and the output orifice 306 can be connected via a channel, where the channel is a hollow portion of the nozzle 302. The nozzle 302 can receive sealant from, for example, a peristaltic pump at the input orifice 304. The sealant can be fed through the channel and be dispensed from the output orifice 306. The nozzle 302 can further include a connecting portion at the proximal end for connecting to a device, such as a peristaltic pump. The connecting portion 308 can be, for example, a screw thread on the outer surface of the inner surface of the channel. In other instances, the connecting portion 308 can be a flexible lip for inserting into a recessed portion of another connecting member. By inserting the flexible lip into the recessed portion of the other connecting member, the nozzle 302 can be locked into place in the other connecting member.

The nozzle 302 can further include a spatula 310. The spatula 310 can include a wiper 312 connected to the distal end of the nozzle 302. For example, as illustrated, the spatula 310 has a conical shape that extends around the distal end of the nozzle. The wiper 312 can have an arcuate structure that partially surrounds the output orifice 306. The wiper 312 can extend away from the output orifice 306, such that a first length (L1) 314 from the input orifice 304 to the output orifice 306 is shorter than a second length (L2) 316 from the input orifice 304 to the tip of the spatula 310. Therefore, the output orifice 306 can be partially surrounded by the spatula 310. The wiper 312 can have a first surface 318 that can be configured to mirror a surface of the target object. For example, if the target object has a flat surface, the first surface 318 can have a flat surface. In some embodiments, the first surface can be the TCP of a robot arm. If the target surface has a convex profile, the first surface can have a concave profile. Conversely, if the target surface has a concave profile, the first surface 318 can have a convex profile. The mirror profiles can allow the first surface 318 of the wiper 312 to be flush with the surface of the target object.

The nozzle 302 can be arranged on a pump mechanism such that the wiper 312 trails the output orifice 306 as the nozzle moves in a forward direction. The first surface 318 can be arranged just above the surface of the target object. In this sense, as the nozzle 302 moves forward, the spatula 310 can collect excess sealant deposited on the target object. The excess sealant can be continuously pushed toward the end of the gap upon which a sealant is being applied.

FIG. 4 is an illustration 400 of a cross-section to receive a sealant, according to one or more embodiments. As illustrated, a first panel 402 can be adjacent to a second panel 404. There can be a gap 406 between the first panel 402 and the second panel 404. A robot can be deployed to dispense a sealant to fill the gap. A cross-section of the gap 406 can include a width (w) 408 and a height (h)410. As a pump mechanism 412 connected to a robotic arm moves along the length (l) 414 of the gap from one side of the first panel 402 and the second panel 404 the cross-sectional dimensions can change. For example, the width (w) 408 can increase or decrease. Additionally, the height (h) 410 can increase or decrease. The changes in the cross-sectional dimensions can be detected by a profiler unit, which can transmit the cross-sectional dimensions to a computing device in real-time.

The amount of sealant that the pump mechanism 412 dispenses can be based on the velocity of the TCP 416, wherein the TCP can be the tip of a nozzle dispensing the sealant. In some instances, the nozzle includes a spatula, and the TCP is a tip of the spatula (see, for example, FIG. 3). The pump mechanism 412 can include a peristaltic pump and the rate that the peristaltic pump dispenses a sealant can be based on the velocity of the TCP. For example, the peristaltic pump can include a rotor assembly connected to a motor. A controller of the computing device can control the motor. The computing device can be local to the robot. The computing device can receive the cross-sectional dimensions from the profiler unit. The computing device can further receive the TCP velocity from the robot. Based on the velocity of the TCP and the cross-section dimensions of the gap 406, the controller can cause the rotor assembly of the peristaltic pump to rotate at a rotational speed that would deposit the target amount of sealant. The target amount of sealant can be an amount that fills the gap to the surface of the first panel 402 and the second panel.

In addition to basing the rotational speed of the rotor assembly of the peristaltic pump on the TCP velocity, the controller can base the rotational speed on a distance (d) 418 between the TCP 416 and the gap 406. The rate at which a sealant dispenses from a nozzle can vary based on the sealant. For example, a sealant with a higher viscosity can take a longer time to travel from the TCP 416 to the gap than a sealant with a lower viscosity. The larger the distance (d) between the TCP 416 and the gap 406, the greater the time differential between a higher viscosity sealant and a lower viscosity sealant. As the distance (d) 418 becomes greater, the pump mechanism 412 can take into account the time required for the sealant to leave an output orifice of a nozzle to reach the gap 406. This can be to prevent the pump mechanism 412 from moving along the length (l) quickly and not depositing enough sealant. Additionally, as the distance (d) 418 becomes smaller, the pump mechanism 412 can take into account the time required for the sealant to leave an output orifice of a nozzle to reach the gap 416. This can be to prevent the pump mechanism 412 from depositing too much sealant while moving slowly at any given point along the gap 406. Therefore, in addition to the TCP velocity, the controller of the computing device can take into account the distance (d) 418 when determining a rotational speed of the rotor assembly of the peristaltic pump.

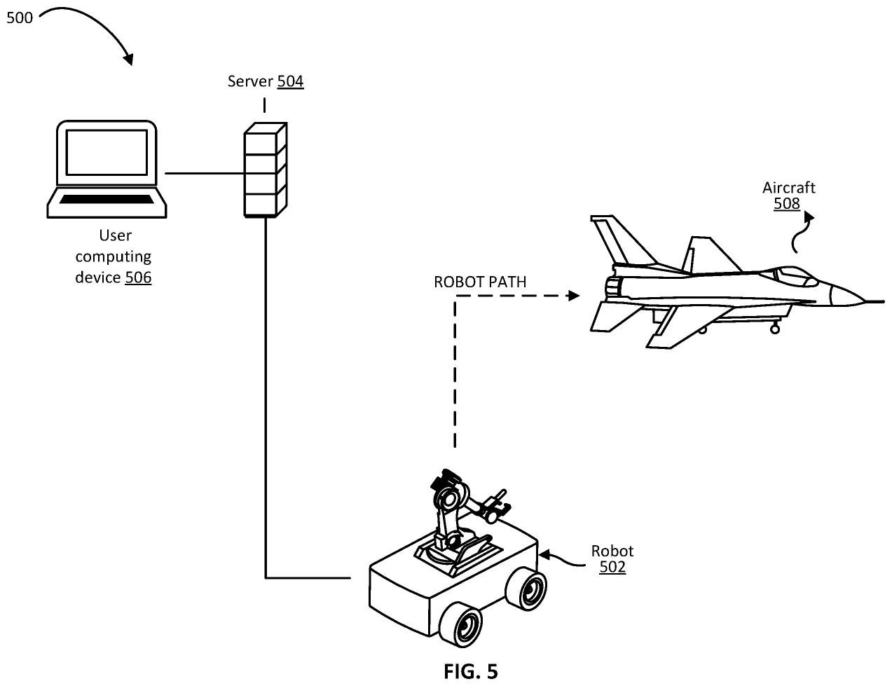

FIG. 5 is an illustration of an environment 500 for dispensing a sealant, in accordance with one or more embodiments. The environment 500 can include a robot 502, a server 504, a user computing device 506 and an aircraft 508. The robot 502 can be in operable communication with the server 504 that, in turn, can be in operable communication with the user computing device 506. The server 504 can include one or more computing devices configured to support the robot 502. The server 504 can be located at the same environment as the robot 502 or the server 504 can be located remotely from the robot 502.

A user can engage with the user computing device 506 to transmit messages to and from the server 504, which can, in turn, transmit and receive messages to and from the robot 502. For example, the messages can include instructions for the robot 502 to perform some operation (e.g., dispense a sealant) on the aircraft 508. The robot 502, the server 504, and the user computing device 506 can be configured to permit the robot to perform autonomous operations on an aircraft 508 and or parts thereof or another real-world object. The autonomous operations can include, for example, dispensing a sealant using a peristaltic pump. It should be appreciated that as illustrated, the user computing device 506 can communicate with the robot 502 via the server 504. In other embodiments, the user computing device 506 can communicate directly with the robot 502, and further the user computing device 506 performs the below described functionality of the server 504.

In addition, the user can use the user computing device 506 to provide instructions to the robot 502, a user can use the user computing device 506 to transmit control instructions to perform an operation on the target aircraft. The user computing device 506 can include a user interface (UI) for providing virtual representations and scanned images of the environment, including the aircraft 508.

The robot 502 can be employed to apply a sealant to the aircraft 508. For example, as part of routine maintenance, the robot 502 can be employed to detect gaps in the aircraft 508, to which a sealant can be applied. The robot 502 can navigate to the operational area and, once at the operational area, perform a set of operations to register the aircraft 510 (or a part thereof) to a TCP (e.g., a tip of the peristaltic pump nozzle. The robot 502 can then perform another set of operations on the aircraft 510 (and/or the airplane part), such as applying a sealant. Some of these operations can be computationally expensive (e.g., a feature identification phase, registration phase, path and trajectory generation phase), whereas other operations can be less computationally expensive and more latency sensitive (e.g., causing a peristaltic pump rotor to rotate). The computationally expensive operation(s) can be offloaded to the server 504, whereas the robot can locally perform the remaining operation(s) 502.

The robot 502 can further use odometry information to calculate a path to traverse the environment to reach the aircraft 508. For example, the robot 502 or the server 504 can calculate a transformation to translate the coordinate system of the aircraft 508 (in a particular section that needs sealant) to the coordinate system of the TCP. Additionally, the robot 502 or the server 504 can calculate, using inverse kinematics, a trajectory (e.g., robot movements) for the robot 502 to follow to reach the aircraft 508 and to apply the sealant. The trajectory can take into account other objects in the environment (e.g., a second aircraft) and include movements to avoid these obstacles. Once the robot different operations are completed, the robot 502 can autonomously return to a parking area or can be summoned to another operational area.

In an example, a robot 502 can include a movable base, a power system, a powertrain system, a navigation system, a sensor system, a robotic arm, an end effector, input and output (I/O) interfaces, and a computer system. The end-effector can support a particular autonomous operation (e.g., sealant dispensing) can be a line-replaceable unit with a standard interface, such that the end-effector can be replaced with another one that supports a different autonomous operation (e.g., sealant dispensing). The robot 502 can carry the end-effector replacement itself or can use a manual process, where an operator can perform the replacement. The I/O interfaces can include a communication interface to communicate with the server 504, and the user computing device 506, for the selection of autonomous operations to be performed by the robot 502. The computer system can include one or more processors and one or more memory storing instructions that, upon execution by the one or more processors, configure the robot 502 to perform different operations. The instructions can correspond to program codes for the navigation, controls of the power system, controls of the powertrain system, the collection and processing of sensor data, the controls of the robotic arm, the controls of the end effectors, and/or the communications.

The robot 502 can include a pump mechanism for dispensing a sealant. The pump mechanism can include a pressure unit for applying pressure to a sealant unit (e.g., sealant reservoir). The pump mechanism can further include a peristaltic pump for receiving sealant from the sealant unit and carrying to the nozzle. The pump mechanism can use the nozzle to dispense a sealant on a target object. The rate of flow of sealant from the pump mechanism can be based on the velocity of the robots TCP and the distance between the TCP and the target object.

The robot 502 can include light detection and ranging (LiDAR) sensors to emit a pulsed laser towards the aircraft 510. The LiDAR sensors can further be configured to collect reflected signals from the aircraft 510. The LiDAR sensors can determine an angle of reflection of the reflected signal and a time elapse (time-of-flight) between transmitting the signal and receiving a reflected signal to determine a position of a reflection point on the surface of the aircraft 508 relative to the LiDAR sensors. The robot 502 can continuously emit laser pulses and collect reflection signals. The robot 502 can transmit the sensor data to the server 504, which can further generate a point cloud of the aircraft 508. The server 504 can further populate a data structure using values derived from the point cloud. The server 504 can retrieve a stored reference model of the aircraft 508.

The server 504 can be a hardware computer system that includes one or more I/O interfaces to communicate with the robot 502 and the user computing device 506. The server 504 can further include one or more processors, and one or more memory storing instructions that, upon execution by the one or more processors, configure the server 504 to perform different operations. The instructions can correspond to program codes for the communications and for processes to be executed locally on server 504 for the robot 502 given data sent by the robot 502. The server 504 can further be configured to store a digital thread that holds values (e.g., fastener positions, contamination locations) associated with the aircraft 508, and over the lifecycle of the aircraft 508. The robot 502 can use one or more of these values to perform one or more operations on the aircraft 508.

The user computing device 506 can be a hardware computer system that includes one or more I/O interfaces to communicate with the server 504 and with the robot 502. The user computing device can further include one or more input interfaces (e.g., a mouse, a keyboard, a touch screen) for receiving user inputs.

In response to one or more inputs, multiple operations may be needed to be performed and inter-dependencies between these operations may exist. For instance, to identify fasteners and/or drill fastener holes on the aircraft 508, the robot 502 can detect the aircraft, identify the aircraft 508, register the aircraft 508 so that it can be located in a local coordinate system of the robot 502, control the robotic arm to move to the environments according to a particular trajectory, and control the end effector to drill. Some of the operations can be computationally expensive and performed less frequently (e.g., generating a simultaneous localization and mapping (SLAM) map, registration), whereas other operations can be computationally less expensive but latency sensitive and performed more frequently (e.g., controlling the robotic arm and end effector). As such, the server 504 can execute processes for the computationally expensive/less frequently performed operations, whereas the robot 502 can locally execute processes for the remaining operations.

In some instances, a user can select one or more inputs for controlling the robot 502. The user computing device 506 can receive the inputs and transmit a message including the inputs to the server 504. The server can include an application for performing one or more operations to control the robot 502. The server 504 can receive and transmit messages to and from the robot 502. For the local operations, the robot 502 can execute the corresponding processes locally and can inform the server 504 of the results of these local operations (e.g., that a sealant was dispensed on the aircraft 508).

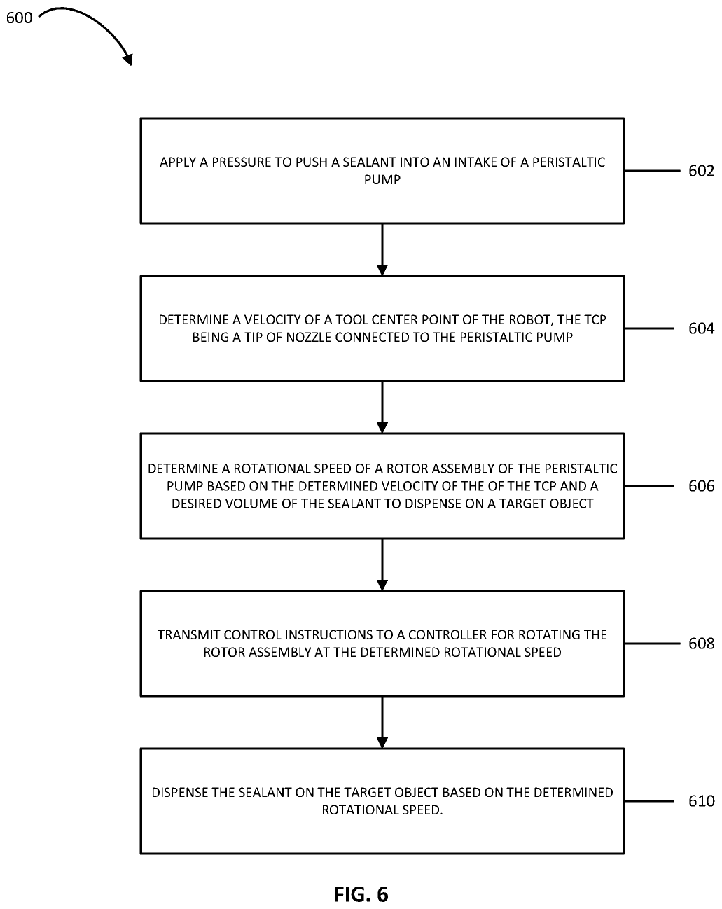

FIG. 6 is a process flow 600 for dispensing a sealant on a target object. A 602, the method can include a robot applying a pressure to push a sealant into an intake of a peristaltic pump. For example, the robot can include a pressure unit (e.g., air cylinder) that can be used to apply pressure to a sealant unit (e.g., sealant reservoir) to cause the sealant to flow into an intake of a peristaltic pump.

At 604, the method can include the robot determining a velocity of a tool center point (TCP) of the robot, the TCP being a tip of a nozzle connected to the robot. The robot can include odometry sensors (e.g., accelerometers, gyroscopes) that can measure a change in position over time.

At 606, the method can include the robot determining a rotational speed of a rotor assembly of the peristaltic pump based on the velocity of the TCP and a target volume of the sealant to dispense on a target object;

At 608, the method can include transmitting control instructions to a controller for rotating the rotor assembly at the determined rotational speed. The controller can be configured for controlling a motor, which includes a shaft connected to the rotor assembly. The rotational speed of the rotor assembly can be based on the rotational speed of the shaft.

At 610, the method can include the robot dispensing the sealant on the target object based on the determined rotational speed. The robot can dispense the sealant on the target object. For example, the robot can dispense sealant to fill a gap between two panels of an aircraft.

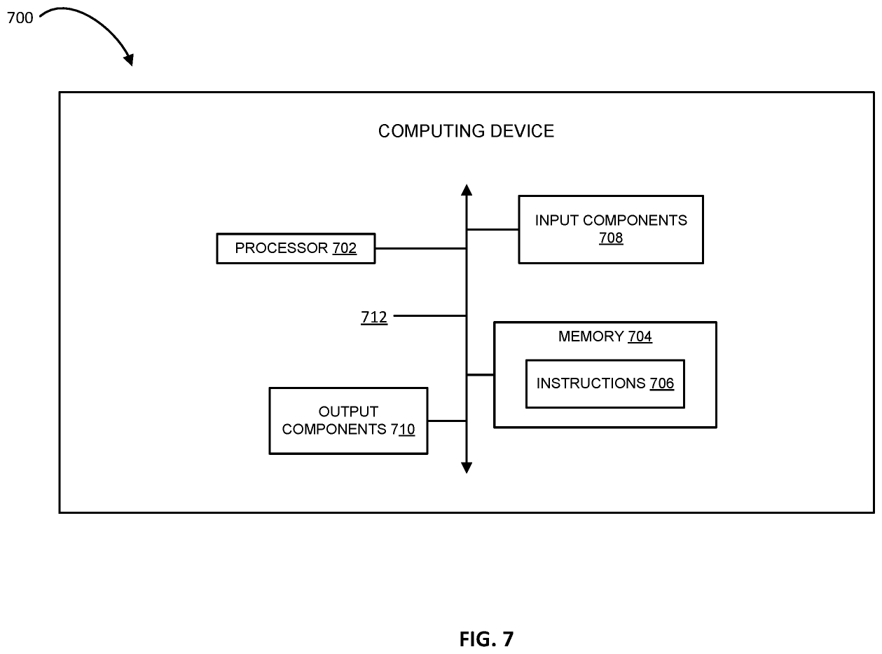

FIG. 7 is a block diagram of an example of a computing device 700 usable for implementing some aspects of the present disclosure. The computing device 700 includes a processor 704 coupled to a memory 704 via a bus 712. The processor 702 can include one processing device or multiple processing devices. Examples of the processor 702 include a Field-Programmable Gate Array (FPGA), an application-specific integrated circuit (ASIC), a microprocessor, or any combination of these. The processor 702 can execute instructions 706 stored in the memory 704 to perform operations. In some examples, the instructions 706 can include processor-specific instructions generated by a compiler or an interpreter from code written in any suitable computer-programming language, such as C, C++, C #, Python, or Java.

The memory 704 can include one memory device or multiple memory devices. The memory 704 may be non-volatile and include any type of memory device that retains stored information when powered off. Examples of the memory 704 can include electrically erasable and programmable read-only memory (EEPROM), flash memory, or any other type of non-volatile memory. At least some of the memory 704 includes a non-transitory computer-readable medium from which the processor 702 can read instructions 706. A computer-readable medium can include electronic, optical, magnetic, or other storage devices capable of providing the processor 702 with computer-readable instructions or other program code. Examples of a computer-readable medium include magnetic disks, memory chips, ROM, random-access memory (RAM), an ASIC, a configured processor, optical storage, or any other medium from which a computer processor can read the instructions 706.

The computing device 700 may also include other input and output (I/O) components. The input components 708 can include a mouse, a keyboard, a trackball, a touch pad, a touch-screen display, or any combination of these. The output components 710 can include a visual display, an audio display, a haptic display, or any combination of these. Examples of a visual display can include a liquid crystal display (LCD), a light-emitting diode (LED) display, and a touch-screen display. An example of an audio display can include speakers. Examples of a haptic display may include a piezoelectric device or an eccentric rotating mass (ERM) device.

The above description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1-8. (canceled)

9. A method performed by a robot, the method comprising:
applying a pressure to push a sealant into an intake of a peristaltic pump;
determining a velocity of a tool center point (TCP) of a tool connected to the robot;
determining a first rotational speed of a rotor assembly of the peristaltic pump based on the velocity of the tool center point (TCP) and a target volume of the sealant to dispense in a gap at a target object;
transmitting control instructions to a controller for rotating the rotor assembly of the peristaltic pump at the determined first rotational speed;
dispensing the sealant in the gap based on the determined first rotational speed;
emitting, while dispensing the sealant in the gap and using a laser profiler, a light-based signal at the gap;
receiving, while dispensing the sealant, a reflected signal from the gap based on the light-based signal;
determining, while dispensing the sealant in the gap, a change in a cross-sectional dimension of the gap based on the reflected signal;
determining, while dispensing the sealant in the gap, a second rotational speed of the rotor assembly of the peristaltic pump based on the change in the cross-sectional dimension of the gap; and
dispensing the sealant in the gap based on the determined second rotational speed of the rotor assembly.

10. The method of claim 9, wherein the method further comprises:
determining a transformation from a coordinate system of a target object that comprises the gap to a coordinate system of the robot based on the TCP; and
determining a trajectory for the tool to traverse a surface of the target object based on the transformation.

11. The method of claim 9, wherein the target object comprises a first aircraft panel adjacent to a second aircraft panel, and wherein the gap is formed between the first aircraft panel and the-second aircraft panel, and wherein the sealant is to fill the gap.

12. The method of claim 11, wherein the target volume of the sealant is based on the cross-sectional dimension of the gap, and wherein the cross-sectional dimension comprise one of a depth of the gap and a width of the gap.

13. The method of claim 12, wherein the method further comprises:
determining a distance from the TCP to a surface of the target object and
determining a rotational speed of a rotor assembly of the peristaltic pump further based on the determined distance.

14. The method of claim 13, wherein the distance is determined based on a measurement by a laser profiler.

15. The method of claim 13, wherein the method further comprises:
traversing a surface of the target object while dispensing the sealant;
adjusting the rotational speed of the rotor assembly based on a measurement by a laser profiler.

16. The method of claim 13, wherein the method further comprises determining the rotational speed of the rotor assembly based on a viscosity of the sealant.

17. A computer-readable medium having stored thereon a sequence of instructions which, when executed, causes a processor to perform operations comprising:
applying a pressure to push a sealant into an intake of a peristaltic pump connected to a robot;
determining a velocity of a tool center point (TCP) of the robot, the TCP being a tip of a nozzle connected to the peristaltic pump;
determining a rotational speed of a rotor assembly of the peristaltic pump based on the determined velocity of the TCP and a target volume of the sealant to dispense on a target object; and
transmitting control instructions to a controller for rotating the rotor assembly at the determined rotational speed.

18. The computer readable medium of claim 17, wherein the instructions which, when executed, further cause the processor to perform operations comprising:
determining a transformation from a coordinate system of the target object to a coordinate system of the robot based on the TCP; and
determining a trajectory for the nozzle to traverse a surface of the target object based on the transformation.

19. The computer readable medium of claim 18, wherein a target volume of the sealant to dispense on a gap between a first aircraft panel and a second aircraft panel is based on cross-sectional dimensions of the gap, and wherein the cross-sectional dimensions comprise a depth of the gap and a width of the gap.

20. The computer readable medium of claim 18, wherein the instructions which, when executed, further cause the processor to perform operations comprising:
determining a distance from the TCP to a surface of the target object; and
determining a rotational speed of a rotor assembly of the peristaltic pump further based on the determined distance.

21. A robot, comprising:
a processor; and
a computer-readable medium including instructions that, when executed by the processor, cause the robot to perform operations comprising:
applying a pressure to push a sealant into an intake of a peristaltic pump;
determining a velocity of a tool center point (TCP) of a tool connected to the robot;
determining a first rotational speed of a rotor assembly of the peristaltic pump based on the velocity of the tool center point (TCP) and a target volume of the sealant to dispense in a gap at a target object;
transmitting control instructions to a controller for rotating the rotor assembly of the peristaltic pump at the determined first rotational speed;
dispensing the sealant in the gap based on the determined first rotational speed;
emitting, while dispensing the sealant in the gap and using a laser profiler, a light-based signal at the gap;
receiving, while dispensing the sealant, a reflected signal from the gap based on the light-based signal;
determining, while dispensing the sealant in the gap, a change in a cross-sectional dimension of the gap based on the reflected signal;
determining, while dispensing the sealant in the gap, a second rotational speed of the rotor assembly of the peristaltic pump based on the change in the cross-sectional dimension of the gap; and
dispensing the sealant in the gap based on the determined second rotational speed of the rotor assembly.

22. The method of claim 9, wherein the method further comprises:
determining a transformation from a coordinate system of a target object that comprises the gap to a coordinate system of the robot based on the TCP; and
determining a trajectory for the tool to traverse a surface of the target object based on the transformation.

23. The method of claim 9, wherein the target object comprises a first aircraft panel adjacent to a second aircraft panel, and wherein the gap is formed between the first aircraft panel and the second aircraft panel, and wherein the sealant is to fill the gap.

24. The method of claim 11, wherein the target volume of the sealant is based on the cross-sectional dimension of the gap, and wherein the cross-sectional dimension comprise one of a depth of the gap and a width of the gap.

25. The method of claim 12, wherein the method further comprises:
determining a distance from the TCP to a surface of the target object and
determining a rotational speed of a rotor assembly of the peristaltic pump further based on the determined distance.

26. The method of claim 13, wherein the distance is determined based on a measurement by a laser profiler.

27. The method of claim 13, wherein the method further comprises:
traversing a surface of the target object while dispensing the sealant;
adjusting the rotational speed of the rotor assembly based on a measurement by a laser profiler.

28. The method of claim 13, wherein the method further comprises determining the rotational speed of the rotor assembly based on a viscosity of the sealant.
